(19) United States
(12) Patent Application Publication
(10) Pub. No.: US 2024/0211978 A1
(43) Pub. Date: Jun. 27, 2024

(54) System and Method for Music Streaming

(71) Applicant: Terrence Dixon, Gary, IN (US)

(72) Inventor: Terrence Dixon, Gary, IN (US)

(21) Appl. No.: 18/598,484

(22) Filed: Mar. 7, 2024

Related U.S. Application Data
(63) Continuation of application No. 17/483,154, filed on Sep. 23, 2021.
(60) Provisional application No. 63/088,689, filed on Oct. 7, 2020.

(51) Int. Cl. G06Q 30/0201; G06F 3/16; H04L 67/141

(52) U.S. Cl. CPC G06Q 30/0201; G06F 3/167; H04L 67/141

(57) ABSTRACT

A system and method for music streaming that that connects a plurality of listener-user devices and one or more artist-user device to communicate and share media files, that provides listener-users with a survey, and provides the one or more artist-user device with a statistical analysis of said surveys. The data is presented to the uploading one or more artist-user device so that they gauge the potential popularity of a media item. Additionally, the system is designed to receive the survey data and calculate a marketability or profitability score which is also presented to the one or more artist-user device. The system includes a method of use and a non-transitory computer readable medium having instructions stored thereon which, when executed, execute the method of use.

### CROSS-REFERENCE TO RELATED APPLICATIONS

This U.S. Continuation Patent Application claims the benefit of U.S. Non-Provisional patent application Ser. No. 17/483,154, filed on Sep. 23, 2021 that claims the benefit of U.S. Provisional Patent Application No. 63/088,689, filed on Oct. 5, 2020. The above identified patent application is herein incorporated by reference in its entirety to provide continuity of disclosure.

### BACKGROUND OF THE INVENTION

The present invention relates to a system and method for music streaming. More specifically, the present invention provides a system and method for music streaming that allows one or more listener-user device and one or more artist-user device to communicate with one another to share and access a media item for the listener-users to evaluate the media item.

With the access that an individual artist has to technology to create and produce high quality songs, there are more artists than ever before creating music for listeners to consume. With such a saturated market of music, listeners may be overwhelmed with the amount of music that they may consume. This oversaturation of the music available for listeners makes it difficult for the artists to standout and have their music be consumed by as many listeners as possible. When the level of consumption for a particular artist's music is low, it may be difficult for the artist to know that the music they are producing will be a successful song that people will want to purchase.

Artists want to produce music that they enjoy making and their fans enjoy consuming. Often the artist will want to find the song that their fans enjoy the most. That way the artist may plan on producing additional content around that song to enhance the fan's experience. The artist may choose to take a song that their fans enjoy and produce a music video or if they want to develop a remix of the song. Some artists believe that if they are able to produce more content for a song that is popular, it may enhance the success of the entire album and reach an additional number of listeners.

Many artists want to only release music that allows them to stay true to their identity so their loyal fans will want to continue to follow and support them. Therefore, the artists do not want to release undesirable or unpopular music. The artist may damage their reputation and may make it difficult for them to continue in their career if they produce music that is undesired by their listeners. Many musicians rely on social media to determine the likelihood of popularity of certain songs. However, social media may generate inconsistent or inaccurate data for the musician. Without any accurate data reflecting the true impressions of the listeners, a musician may make a poor decision that affects their future endeavors.

Therefore, what is needed is a system and method for music streaming that that connects one or more listener-user device and one or more artist-user device to communicate and share media files, that provides one or more listener-users with a survey, and provides the one or more artist-user device with a statistical analysis of said surveys.

### SUMMARY OF THE INVENTION

In view of the foregoing disadvantages inherent in the known types of systems and methods for music streaming now present in the known art, the present invention provides a new system and method for music streaming wherein one or more artist-user device may receive a marketability score and a profitability score based on a survey completed by one or more listener-user on the one or more listener-user device.

The present system is a system for music streaming that includes a server system with a processor system, a communications interface, a communications system, an input system and an output system, the server system having access to a communications network; a memory system with an operating system, a communications module, a web browser module, a web server application and a non-transitory computer readable medium for music streaming, the memory system is in communication with the server system through the communications network; a media item residing on the non-transitory computer readable medium for music streaming; and a survey residing on the non-transitory computer readable medium for music streaming that evaluates the media item.

The present system also includes a corresponding method for music streaming that includes the steps of establishing communication between at least one system (wherein the system includes a non-transitory computer readable medium, at least one processor, at least one artist-user device and at least one listener-user device.), registering, by the system, a plurality of existing data from a database server, registering, by the at least one artist-user device, a media item, creating a database server of the media item from the at least one artist-user device, the media item from the at least one artist-user device comprises of an existing portion of the existing data, transmitting the media item to the at least one listener-user device, transmitting a survey to the at least one listener-user device, defining the survey with a plurality of questions each with a binary answer, receiving the survey with the questions each with the binary answer completed from the at least one listener-user device, analyzing the survey from the at least one listener-user device, generating, from the survey, at least one number value, wherein the at least one number value is a marketability score and the at least one number value is a profitability score; and transmitting the at least one number value to the artist-user device.

The present system also includes a corresponding non-transitory computer readable medium having instructions stored thereon which, when executed, execute the method for music streaming comprising the steps of.

It is an object of the present invention to provide a system and method for music streaming that the one or more artist-user devices may receive a marketability score and a profitability score based on a survey completed by their listener-users.

It is an object of the present invention to provide a system and method for music streaming that allows one or more listener-user devices and one or more artist-user devices to communicate with one another to share and access a media item for the listener-users to evaluate the media item.

It is an object of the present invention to provide a system and method for music streaming that utilizes a Quick Release or QR Code for one or more listener-users to complete a survey on one or more artist-user devices.

It is an object of the present invention to provide a system and method for music streaming that utilizes a Disc Jockey or DJ input as part of a survey.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of an embodiment of a system for music streaming.

FIG. 2A shows a block diagram of an embodiment of a client system of the system for music streaming.

FIG. 2B illustrates a block diagram of an embodiment of a server system of the system for music streaming.

FIG. 3 shows a diagram of an embodiment of a method for music streaming.

FIG. 4 shows a front view of an embodiment of a display of the client system of the system for music streaming.

FIG. 5 shows a perspective view of an embodiment of a display of the system and method for music streaming.

### DETAILED DESCRIPTION OF THE INVENTION

Reference is made herein to the attached drawings. Like reference numerals are used throughout the drawings to depict like or similar elements of a system and method for music streaming. The figures are intended for representative purposes only and should not be considered to be limiting in any respect.

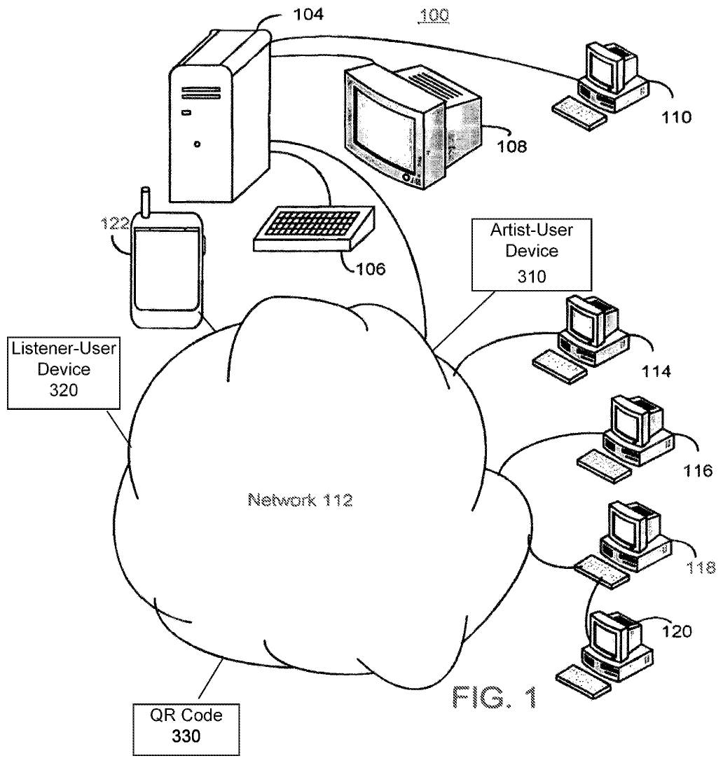

Referring now to FIG. 1, there is shown a system overview of a system for music streaming 100.

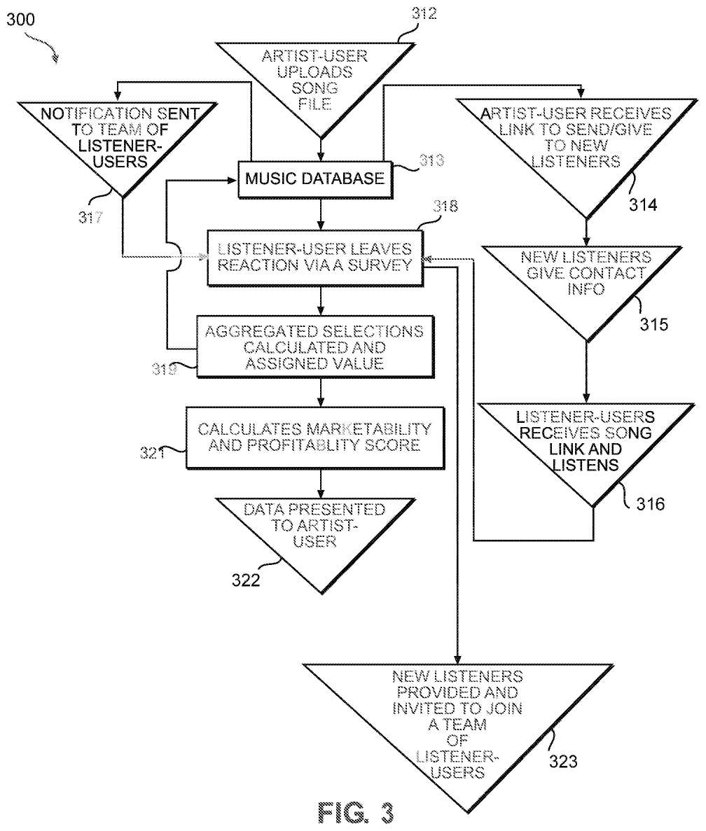

The overall system 100 may include a server system 104, an input system 106, an output system 108, a plurality of client systems 110, 114, 116, 118 and 120, a communications network 112, a hand-held device 122, a plurality of listener-user devices (FIG. 3, 320) and a plurality of artist-user devices (FIG. 3, 310). In other embodiments, the overall system 100 may include additional components and/or may not include all of the components listed above.

The server system 104 may include one or more servers. The server system 104 may be the property of the distributor of any related software or non-transitory computer readable medium. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the client systems 110, 114, 116, 118, and 120 and are connected via the communications network 112. The client system 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118, and 120 may be any system that an end user may use to access the server system 104. For example, the client systems 110, 114, 116, 118, and 120 may be one or more personal computers, one or more workstations, one or more laptop computers, one or more game consoles, one or more handheld network enabled audio/video players and/or any other network appliance.

The client system 120 may access the server system 104 via the combination of the communications network 112 and another system, which in this example is the client system 118. The client system 120 may be an example of a handheld wireless device 122, such as a mobile phone or a handheld network enabled audio/music player or the like, which may also be used for accessing network content.

The listener-user devices 320 and the artist-user devices 310 may be described in more detail in FIGS. 3-6.

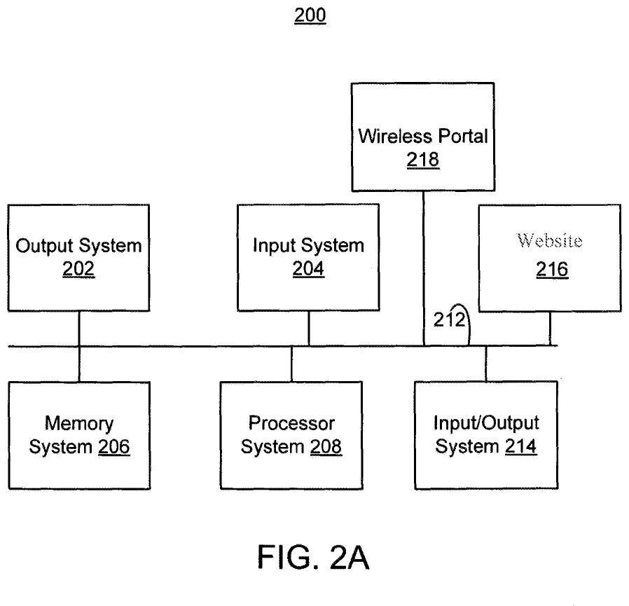

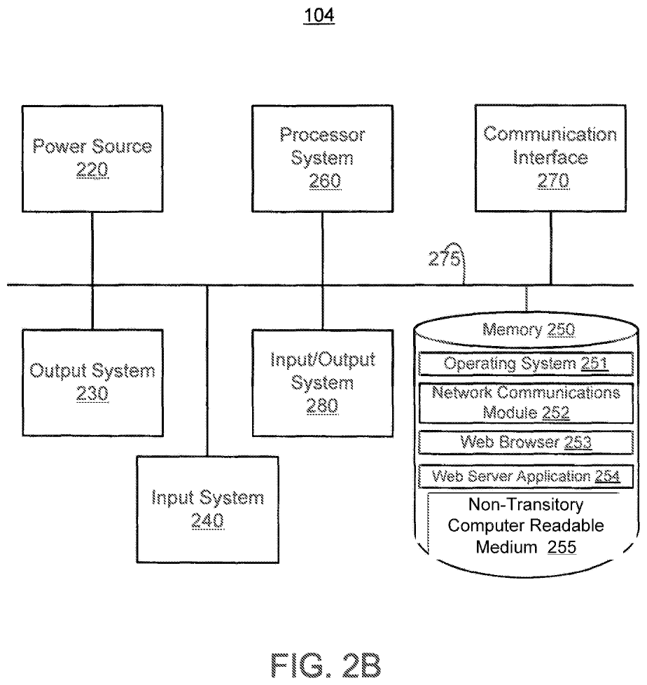

Referring now to FIG. 2A there is shown a block diagram of a client system 200 of the system for music streaming 100.

The client system 200 may include an output system 202, an input system 204, a memory system 206, a processor system 208, a communications system 212, an input/output system 214, a website 216, and a wireless portal 218. Other embodiments of the client system 200 may not have all of the components and/or may have other embodiments in addition to or instead of the components listed above.

The client system 200 may be any one of the client systems 110, 114, 116, 118, and 120, and/or the handheld wireless device 122 that may be used as one of the network devices of FIG. 1. In other embodiments, the client system 200 may include additional components and/or may not include all of the components listed above.

The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of, or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example.

The memory system 206 may include, for example, any one of, some of, any combination of, or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium may be used to refer to any medium that is structurally configured for carrying information in a format that is readable by a machine. One example of a machine-readable medium is a computer-readable medium. The memory system 206 may also store a non-transitory computer readable medium for music streaming.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system 212 may communicatively button the output system 202, the input system 204, the memory system 206, the processor system 208, and/or the input/output system 214 to each other. The communications system 212 may include any one of, some of, any combination of, or all of one or more electrical cables, one or more fiber optic cables, and/or one or more means for sending signals through air or water (i.e., wireless communications), or the like. Some examples of means for sending signals through air and/or water may include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 may be optional and may be used in addition to or in place of the output system 202 and/or the input device 204.

The client systems 110, 114, 116, 118, and 120 and the handheld wireless device 122 may also be tied into a website 216 or a wireless portal 218 which is also tied directly into the communications system 212. Any website 216 or wireless portal 218 would also include software and a website module to maintain, allow access to and run the website as well.

FIG. 2B shows a block diagram of a server system 104 of the system for music streaming 100.

The server system 104 may include a power source 220, an output system 230, an input system 240, a memory system 250, which may store an operating system 251, a communications module 252, a web browser module 253, a web server application 254, and a non-transitory computer readable medium for music streaming 255. The server system 104 may also include a processor system 260, a communications interface 270, a communications system 275, and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination

of, or all of a long-term storage system, such as a hard drive; a short-term storage system, such as a random-access memory; a removable storage system, such as a floppy drive or a removable drive and/or a flash memory. The memory system 250 may include one or more machine-readable mediums that may store a variety of different types of information. The term machine-readable medium may be used to refer to any medium capable of carrying information that is readable by a machine. One example of a machine-readable medium may be a computer-readable medium. The memory system 250 may store one or more machine instructions for reading, searching and enhancing a system and method for music streaming. The operating system 251 may control all software or non-transitory computer readable medium and hardware of the overall system 100. The communications module 252 may enable the server system 104 to communicate on the communications network 112. The web browser module 253 may allow for browsing on the Internet. The web server application 254 may serve a plurality of web pages to client systems that request the web pages, thereby facilitating browsing on the Internet. The non-transitory computer readable medium 255 may be a non-transitory computer readable medium for music streaming or the like that may be a set of instructions that tells the overall system 100 what to do and how to do it. The non-transitory computer readable medium 255 may be a computer program that provides instructions to execute a user's commands regarding music streaming.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, one or more fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

FIG. 3 shows a diagram of an embodiment of a method for music streaming 300.

The method for music streaming 300 may incorporate input from one or more artist-user device 310 and one or more listener-user device 320.

The one or more artist-user device 310 may include one or more cameras, one or more microphones, one or more mixers, one or more ring lights, one or more backdrops, one or more filters and distortion lens, one or more selfie ring light clips, and one or more Soft box lighting kits and the like.

The one or more artist-user device 310 may include equipment for music files that may include one or more synthesizers (Synthesizers are electronic devices that are used to generate sounds. They may imitate existing sounds (e.g., a piano) or create new and unique sounds (e.g., an electric guitar). Synthesizers are used to generate sounds by generating waveforms in a variety of ways, including subtractive synthesis, additive synthesis, and frequency modulation synthesis.), one or more drum machines, one or more samplers, one or more sequencers, one or more MIDI controllers (These electronic devices are used to create and manipulate sounds. They may be used to play notes, trigger samples, and control effects. MIDI (Musical Instrument Digital Interface) controllers come in a variety of shapes and sizes, from simple ones that look like keyboards to more complex ones that have multiple pads and faders.), one or more audio interfaces (An audio interface is a device used to convert analog audio signals into digital audio signals. Audio interfaces are used in a variety of settings, including recording studios, live sound venues, and home studios.), one or more equalizers (Equalizers are used to adjust the level of specific frequencies in an audio signal. They may be used to boost or cut certain frequencies, which may help achieve the desired sound (e.g., making a guitar sound brighter or a kick drum sound more powerful).), one or more compressors/limiters (Compressors and limiters are used to control the dynamics of an audio signal. They may be used to reduce the level of loud peaks (e.g., a drum hit), or to increase the overall level of a signal (e.g., vocals).), and one or more effects units, reverb, delay, and looping devices (These devices may be used to process and manipulate the sound of an electronic instrument or voice. They may also be used to create special effects, such as echo or delay. Some effects units may be used to create loops, which allow a musician to repeat a section of music over and over again.).

The one or more artist-user device 310 uploads a file 312 onto a database server 313. In the shown embodiment, the file that the one or more artist-user devices 310 uploads on to the database server 313 contains a media item. For example, the media item may be an audio file containing a song. The database server 313 comprising a processor, a non-transitory computer readable medium operatively connected to the processor, and a logic stored in the non-transitory computer readable medium that, when executed by the processor, causes the system to perform a method.

Upon the uploading of the media item by the one or more artist-user device 310, the listener-user device 320 may be notified 317 of the newly uploaded file. The listener-user device 320 may receive the notification 317 have previously provided their contact information. The contact information may include the listener-user device's 320 telephone number or e-mail address. Moreover, the one or more artist-user device 310 will receive a link that may be sent to new listeners 314. The new listener-user devices 320 that receive the link to the database server 313 from the one or more artist-user device 310 to provide their contact information 315 to become a listener-user device 320 that may access the database server 313 and the uploaded file. After the new listener-user device 320 provides their contact information 315, the listener-user device 320 will receive the link to access the uploaded media item and listen to the media item 316. The newly joined listener-users may link their account with groups of other listener-users that enjoy similar music and artist 323. In this way, the users may receive the notifications 317 when the artist or similar music they enjoy is uploaded by one or more artist-user device 310.

The listener-user will react to the media item that is uploaded by the one or more artist-user device 310 after they consume the song. One way that the listener-user will react to the media item is by completing a survey 318. The listener-user will complete the series of questions that are within the survey to accurately express their thoughts to the media item. As more listener-users consume the media item and ultimately complete the reaction survey, all of the survey findings will be aggregated and calculate a value to assign to the media item 319. The calculated and assigned value 319 will be stored in the database server 313 along with the media item. In some embodiments, the listener-user will be compensated after completing the survey. The compensation will encourage all the listener-users to complete the survey so the one or more artist-user device 310 may get as much information regarding the reception of the media item as possible.

With the calculated and assigned value 319 that results from listener-users leaving their reactions to uploaded music, in form of a survey 318, the system and method for music streaming 311 may provide the user-artist with specific calculations. The system and method for music streaming 311 utilizes the calculated and assigned value 319 for a media item to calculate a marketability score and a profitability score 321. The marketability score is a quantifiable value that provides the one or more artist-user device 310 with marketing data and a calculation based on that gathered data to allow the one or more artist-user device 310 informed decision before releasing the media item on the marketplace. The profitability score is a quantifiable value that provides the one or more artist-user device 310 with data that predicts the potential profits that the one or more artist-user device 310 may make when the media item is released. The marketability score and the profitability score are determined from the response from the listener-users in the survey 318 being compared to previous media items with similar survey responses that either had from success or failure when produced. The marketability score and the profitability score will be sent to the one or more artist-user device 310. With the marketability score and the profitability score, the one or more artist-user device 310 will be able to interpret the data and make a prediction on the success that their media item if they consider making their music available for purchase.

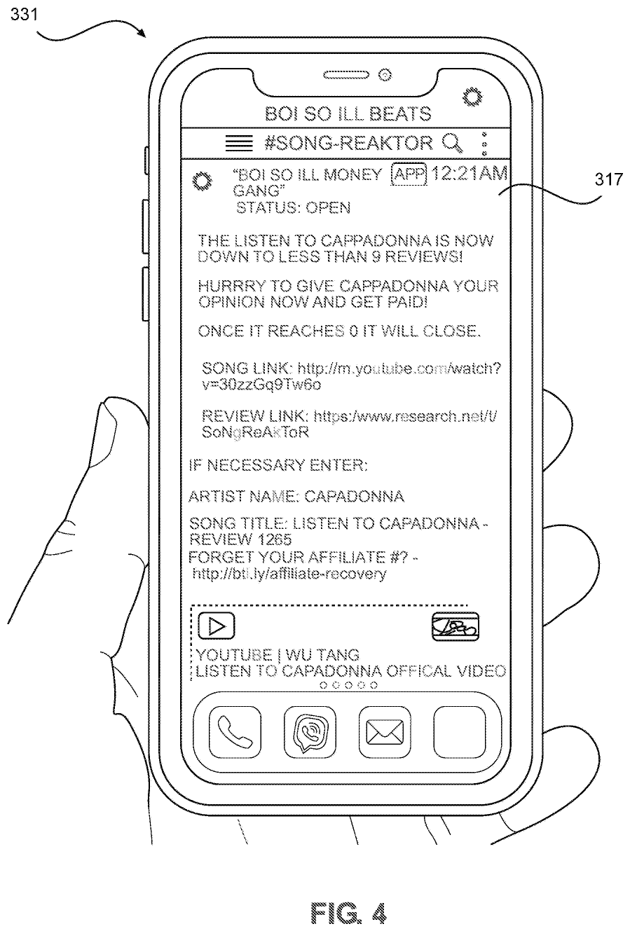

FIG. 4 shows a front view of an embodiment of a display of the system and method for music streaming.

For a listener-user, they may access the system and method for music streaming on an electronic device 331. The listener-user will access the system and method for music streaming when an application is launched. A user interface 317 will be displayed on the electronic device when the application is launched.

The user interface 317 provides the user with specific information regarding the media item and a plurality of actionable features. Among the information that is provided to the listener-user on the user interface 317 is the title of the media item, the name of the one or more artist-user device 310 that uploaded the media item, and the number of reviews that have been entered for the media item by other listener-users.

A first actionable feature of the plurality of actionable features is a song link. When engaged by the listener-user on the user interface 317, the song link will transport the listener-user from the user interface 317 to the media item. When accessing the media item, the listener-user may control the playing of the media item. Specifically, the listener-user may play, pause, fast-forward, or replay the media item to their liking. After the listener-user consumes the media item, they may return to the user interface 317.

Once returned to the user interface 317, a second actionable feature of the plurality of actionable features is a review link. When engaged by the listener-user on the user interface 317, the review link will transport the listener-user from the user interface 317 to a survey. When accessing the survey, the listener-user may input responses to the predetermined questions regarding their enjoyment of the media item.

The survey that is filled out by the listener-user following them listening to the media item comprises a plurality of questions. The plurality of questions further includes binary answers. In one embodiment, the listener-user will elect which one of the binary answers accurately reflect their opinion of the media item. When selected, the binary answer of a yes or no answer results in a value being assigned to the media item. As additional listener-users begin to fill out their survey, the values will be aggregated. The aggregated values will calculate a score associated to the media item. The scores that are determined will be provided to the one or more artist-user device 310 along with a predictable value on the marketability and the profitability of the media item.

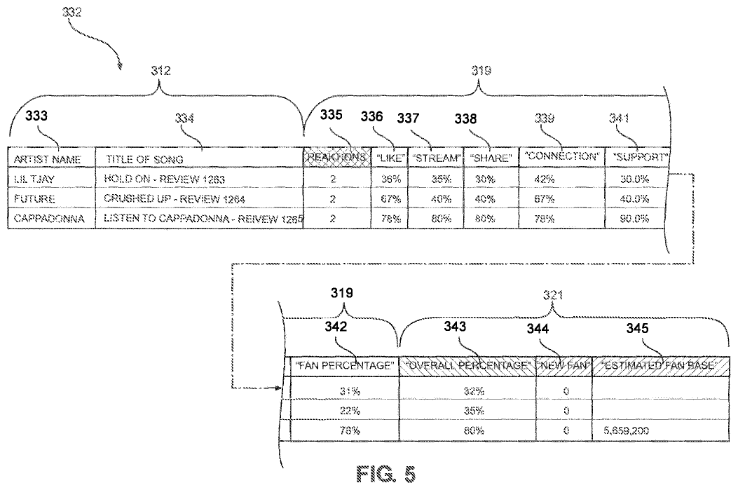

FIG. 5 shows a perspective view of an embodiment of a display of the system and method for music streaming.

The display of the system and method for music streaming 332 allows the one or more artist-user device 310 to access and view all of the findings from the listener-user's survey. The display of the system and method for music streaming 332 contains a plurality of identifiable information 312, a plurality of aggregated data 319, and a plurality of calculated data 321.

The identifiable information 312 includes an artist's name 333 and a title of the song 334. The identifiable information 312 allows the user to associate the calculated values to the specific media item. The aggregated data 319 includes a plurality of data that is collected based on the collected information on the surveys submitted by the listener-users.

First, a listener-user counter 335 is included in the aggregated data 319. The listener-user counter 335 indicates the number of listener-users that have opened the review link and completed the survey. In the survey, the listener-user will be given a first question of the plurality of questions that asks if the listener-user liked the media item. The survey will include binary answers for the listener-user to select to express their opinion on their likeability of the media item. The results of the surveys will calculate a like-percentage 336. The one or more artist-user device 310 will view the cumulative results of all the listener-users surveys in the like-percentage 336 on the display of the system and method for music streaming 332.

A second question of the plurality of questions asks if the listener-user would stream the media item. The survey will include binary answers for the listener-user to select to express their opinion on the chances they stream the media item. The results of the surveys will calculate a stream-percentage 337. The one or more artist-user device 310 will view the cumulative results of all the listener-users surveys in the stream-percentage 337 on the display of the system and method for music streaming 332.

A third question of the plurality of questions asks if the listener-user would share the media item to others. The survey will include binary answers for the listener-user to select to express their opinion on the chances they share the media item. The results of the surveys will calculate a share-percentage 338. The one or more artist-user device 310 will view the cumulative results of all the listener-users surveys in the share-percentage 338 on the display of the system and method for music streaming 332.

A fourth question of the plurality of questions asks if the listener-user felt a connection to the media item. The survey will include binary answers for the listener-user to select to express their opinion on whether they connected to the media item. The results of the surveys will calculate a connection-percentage 339. The one or more artist-user device 310 will view the cumulative results of all the listener-users surveys in the connection-percentage 339 on the display of the system and method for music streaming 332.

A fifth question of the plurality of questions asks if the listener-user would support the media item by purchasing the media item. The survey will include binary answers for the listener-user to select to express their opinion on the chances they would support the media item. The results of the surveys will calculate a support-percentage 341. The one or more artist-user device 310 will view the cumulative results of all the listener-users surveys in the support-percentage 341 on the display of the system and method for music streaming 332.

The aggregated data 319 reveals a fan-percentage 342 on the display of the system and method for music streaming 332. Listener-users may be followers of one or more artist-user device 310. When the one or more artist-user device 310 upload any new media item, the listener-users that follow the one or more artist-user device 310 will be notified. The listener-users that follow the one or more artist-user device 310 that listen to the media item will be displayed as a fan-percentage 342. The one or more artist-user device 310 will be able to know how many of their listener-user followers have listen to the media item.

The calculated data 321 shown on the display of the system and method for music streaming 332 provides the one or more artist-user device 310 with information to help them determine marketability and profitability. The calculated data 321 includes an overall percentage 343. The overall percentage 343 is calculated based upon all of the percentages that were determined in the aggregated data 319. The overall percentage 343 provides the one or more artist-user device 310 with a single value of the reception of the media item to determine if the media item will be marketable. The calculated data 321 also includes the number of listener-users that selected to receive notifications from the one or more artist-user device 310 as new fans 344 after they have listened to the media item. Moreover, the calculated data 321 will show the one or more artist-user device 310 what an algorithm determines will be an estimated number of fans that would enjoy the media item 345. For the one or more artist-user device 310, knowing the estimated number of fans that would enjoy their media item 345 would allow them correctly evaluated the media item's profitability. Specifically, the one or more artist-user device 310 will know the probability for success in the marketplace and be capable of making an intelligent, educated decision based on the calculated data 321 as to which media file they want to select as their single, shoot a video for or put on their album.

The overall method of use for the system for music streaming is fairly complex. The overall method may include establishing communication for an overall system for music streaming, registering a plurality of existing data from a database server, registering a media item, creating a database server of the media item from the at least one artist-user device, transmitting the media item, transmitting a survey, defining the survey with a plurality of questions, receiving the survey with the questions each with the binary answer, analyzing the survey, generating from the survey at least one number value, and transmitting the at least one number value to the artist-user device.

The establishing communication step may include the overall system for music streaming that may include a non-transitory computer readable medium, at least one processor, at least one artist-user device, and at least one listener-user device. The first registering step may include registering is done by the overall system for music streaming. The second registering step may include registering is done by the at least one artist-user device. The creating step may include the media item from the at least one artist-user device comprising of an existing portion of the existing data. The first transmitting step may include the media item is transmitted to the at least one listener-user device. The second transmitting step may include the survey is transmitted to the at least one listener-user device. The defining step may include the questions each have a binary answer. The receiving step may include the binary answer is completed from the at least one listener-user device. The analyzing step may include the survey is analyzed from the at least one listener-user device. The generating step may include the at least one number value is a marketability score. The transmitting step may include the at least one number value is a profitability score.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for music streaming, comprising:
a server system with a processor system, a communications interface, a communications system, an input system and an output system, the server system having access to a communications network; and
a memory system with an operating system, a communications module, a web browser module, a web server application and a non-transitory computer readable medium for music streaming, the memory system is in communication with the server system through the communications network;
a media item residing on the non-transitory computer readable medium for music streaming; and
a survey residing on the non-transitory computer readable medium for music streaming that evaluates the media item.

2. The system according to claim 1, further comprising one or more artist-user devices and one or more listener-user devices that accesses the server system via the communications network.

3. The system according to claim 2, further comprising a user interface with a plurality of specific information regarding the media item and a plurality of actionable features displayed on the one or more artist-user devices and the one or more listener-user devices.

4. The system according to claim 3, wherein the specific information regarding the media item includes a title of the media item, the name of the one or more artist-user devices that uploaded the media item, and a number of reviews that have been entered for the media item by other listener-users.

5. The system according to claim 3, wherein the actionable features include a song link to transport the listener-user from the user interface to the media item to control playing the media item and play, pause, fast-forward, or replay the media item.

6. The system according to claim 3, wherein the actionable features include a review link to transport the listener-user from the user interface to a survey.

7. The system according to claim 6, wherein the survey is filled out by the listener-user following them listening to the media item comprising a plurality of questions that include a plurality of binary answers.

8. The system according to claim 6, wherein the listener-user will elect which one of the binary answers that accurately reflect their opinion of the media item.

9. The system according to claim 6, wherein the binary answers of “yes” or “no” result in a value being assigned to the media item.

10. The system according to claim 9, wherein the binary answers of “yes” or “no” accurately reflect an opinion of the media item and a value being assigned to the media item.

11. The system according to claim 9, wherein the surveys from a plurality of additional listener-users begin to fill out their survey, the values from all of the surveys will be aggregated and will each calculate a score associated to the media item.

12. The system according to claim 11, wherein the scores that are determined will be provided to the one or more artist-user devices along with a predictable value on marketability and profitability of the media item.

13. The system according to claim 11, further comprising a display of the system for music streaming that allows the one or more artist-user devices to access and view all of the findings from the listener-user's survey.

14. The system according to claim 11, wherein the display contains a plurality of identifiable information, a plurality of aggregated data, and a plurality of calculated data.

15. The system according to claim 11, wherein the listener-user will be given a first question of the plurality of questions that asks if the listener-user liked the media item, a second question of the plurality of questions that asks if the listener-user would stream the media item, a third question of the plurality of questions that asks if the listener-user would share the media item to others, a fourth question of the plurality of questions that asks if the listener-user felt a connection to the media item, a fifth question of the plurality of questions that asks if the listener-user would support the media item by purchasing the media item.

16. The system according to claim 5, wherein the one or more listener-user device downloads the survey from a QR code.

17. The system according to claim 5, wherein the survey includes a plurality of DJ input as part of the survey.

18. The system according to claim 1, wherein the media item is a music file.

19. A method for music streaming, comprising the steps of:
establishing communication for an overall system for music streaming that includes a non-transitory computer readable medium, at least one processor, at least one artist-user device and at least one listener-user device;
registering a plurality of existing data from a database server;
registering a media item done by the at least one artist-user device;
creating a database server of the media item from the at least one artist-user devices that comprises an existing portion of the existing data;
transmitting the media item to the at least one listener-user devices;
transmitting a survey to the at least one listener-user devices;
defining the survey with a plurality of questions that each have a binary answer;
receiving the survey with the questions each with the binary answer completed from the at least one listener-user device;
analyzing the survey from the at least one listener-user devices;
generating from the survey at least one number value which is a marketability score;
transmitting the at least one number value to the artist-user device which is a profitability score.

20. A non-transitory computer readable medium having instructions stored thereon which, when executed, execute a method for music streaming comprising the steps of:
establishing communication for an overall system for music streaming that includes a non-transitory computer readable medium, at least one processor, at least one artist-user device and at least one listener-user device;
registering a plurality of existing data from a database server;
registering a media item done by the at least one artist-user devices;
creating a database server of the media item from the at least one artist-user devices that comprises an existing portion of the existing data;
transmitting the media item to the at least one listener-user devices;
transmitting a survey to the at least one listener-user devices;
defining the survey with a plurality of questions that each have a binary answer;
receiving the survey with the questions each with the binary answer completed from the at least one listener-user devices;
analyzing the survey from the at least one listener-user devices;
generating from the survey at least one number value which is a marketability score;
transmitting the at least one number value to the artist-user device which is a profitability score.
